(19) United States
(12) Patent Application Publication
(10) Pub. No.: US 2024/0110092 A1
(43) Pub. Date: Apr. 4, 2024

(54) METHOD OF WATERFLOODING USING INJECTION SOLUTIONS CONTAINING DIHYDROGEN PHOSPHATE

(71) Applicant: Saudi Arabian Oil Company, Dhahran (SA)

(72) Inventors: Moataz Abu Al Saud, Khobar (SA); Salem Khaled Al-Shammari, Dhahran (SA); Hussain Habib Al Saleem, Dhahran (SA); Salah Hamad Al-Saleh, Dhahran (SA); Subhash Ayirala, Dhahran (SA); Ali Yousef, Dhahran (SA)

(21) Appl. No.: 17/956,569

(22) Filed: Sep. 29, 2022

(51) Int. Cl. C09K 8/58

(52) U.S. Cl. CPC C09K 8/58

(57) ABSTRACT

Provided are methods of increasing the production of a hydrocarbon from a subterranean formation by waterflooding with injection solutions containing dihydrogen phosphate ions.

### TECHNICAL FIELD

The disclosure describes methods of waterflooding using injection solutions containing dihydrogen phosphate ions (H₂PO₄⁻). The concentration of dihydrogen phosphate ions in the injection solutions can be tapered.

### BACKGROUND

Efficient and effective practices of oil production from subterranean formations require a detailed understanding of the physicochemical processes relevant to the oil recovery process. Water injection is a widely used method for improving hydrocarbon recovery. The injection water or brine is typically underground aquifer water, surface water, and/or seawater, depending on the location of subterranean formation and water sources. Injection water salinity plays a major role in governing oil recovery from carbonate formations due to its strong effect on wettability. Specifically, some individual ions dissolved in brines have been shown to have favorable effects on the wettability, while other ions have not shown any impact on the reservoir wettability. Thus, there is a need for a method for providing favorable wettability alteration and enhanced oil recovery in carbonates

### SUMMARY

Provided in the present disclosure is a method of waterflooding. In some embodiments, the method of waterflooding includes introducing a first injection solution including about 400 ppm to about 1000 ppm of dihydrogen phosphate ions into a subterranean formation; and introducing a second injection solution including dihydrogen phosphate ions into the subterranean formation, wherein the second injection solution has a concentration of dihydrogen phosphate ions of about 200 ppm to about 800 ppm, and a concentration of dihydrogen phosphate ions of at least about 200 ppm less than the first injection solution, and wherein at least a portion of a hydrocarbon present in the subterranean formation is displaced.

In some embodiments, the first injection solution has a pH of about 5.0 to about 5.5.

In some embodiments, the second injection solution has a pH of about 5.0 to about 5.5.

In some embodiments, the first injection solution includes seawater.

In some embodiments, the second injection solution includes seawater.

In some embodiments, an amount of the first injection solution introduced into the subterranean formation is about 0.3 to about 0.5 pore volumes.

In some embodiments, an amount of the second injection solution introduced into the subterranean formation is about 0.3 to about 0.5 pore volumes.

In some embodiments, the first injection solution includes about 1000 ppm of dihydrogen phosphate ions.

In some embodiments, the first injection solution includes seawater.

In some embodiments, the second injection solution includes seawater.

In some embodiments, the method of waterflooding further includes introducing a chase solution, including aquifer water, surface water, seawater, or combinations thereof, into the subterranean formation.

In some embodiments, an amount of the chase solution introduced into the subterranean formation is about 0.5 to about 1.0 pore volumes.

In some embodiments, the subterranean formation includes a carbonate formation.

In some embodiments, the first injection solution is introduced after primary production of a hydrocarbon from the subterranean formation.

In some embodiments, the method of waterflooding further includes producing the hydrocarbon from the subterranean formation.

Also provided in the present disclosure is a method of waterflooding, including introducing a first injection solution including about 1000 ppm of dihydrogen phosphate ions into a subterranean formation; introducing a second injection solution including about 800 ppm of dihydrogen phosphate ions into the subterranean formation; introducing a third injection solution including about 600 ppm of dihydrogen phosphate ions into the subterranean formation; introducing a fourth injection solution including about 400 ppm of dihydrogen phosphate ions into the subterranean formation; and introducing a fifth injection solution including about 200 ppm of dihydrogen phosphate ions into the subterranean formation, wherein at least one of the first injection solution, the second injection solution, the third injection solution, the fourth injection solution, and the fifth injection solution displaces at least a portion of a hydrocarbon present in the subterranean formation.

In some embodiments, the first injection solution, the second injection solution, the third injection solution, the fourth injection solution, and/or the fifth injection solution has a pH of about 5.0 to about 5.5.

In some embodiments, the first injection solution, the second injection solution, the third injection solution, the fourth injection solution, and/or the fifth injection solution includes seawater.

In some embodiments, an amount of the first injection solution, the second injection solution, the third injection solution, the fourth injection solution, and/or the fifth injection solution introduced into the subterranean formation is about 0.3 to about 0.5 pore volumes.

In some embodiments, the method of waterflooding further includes injecting a chase solution, including aquifer water, surface water, seawater, or combinations thereof, into the subterranean formation.

In some embodiments, an amount of the chase solution introduced into the subterranean formation is about 0.5 to about 1.0 pore volumes.

In some embodiments, the subterranean formation includes a carbonate formation.

In some embodiments, the first injection solution is introduced after primary production of a hydrocarbon from the subterranean formation.

In some embodiments, the method of waterflooding further includes producing the hydrocarbon from the subterranean formation.

### DESCRIPTION OF DRAWINGS

FIG. 1 shows various ions inside a thin-film water layer squeezed between a calcite surface and crude oil.

FIG. 2 shows the zeta potential values at a calcite/brine interface for different brine solutions.

FIG. 3 shows the zeta potential values at a crude oil/brine interface for different brine solutions.

FIGS. 4A and 4B show contact angles for different brine solutions. FIG. 4A shows seawater without salt additives and FIG. 4B shows seawater with 1000 ppm of sodium dihydrogen phosphate.

FIG. 5 shows experimental and modeled zeta potential values at a calcite/brine interface for different brine solutions.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Water injection can be used to improve hydrocarbon recovery from a subterranean formation by increasing the pressure in the subterranean formation and displacing the hydrocarbons. Water injection can be performed after primary recovery of the subterranean formation. Underground aquifer, surface water and/or seawater can be used as the injection water depending on the location. Typically, for a pH between 5 and 8, the brine/crude oil zeta-potential is negative due the carboxylate groups in the crude oil surface, while the brine/carbonate zeta-potential is positive due to dissolved magnesium and calcium ions in brine solutions that interact and adsorb on the calcite surface. Salinity of the injection water can alter the surface charges and corresponding zeta-potential, thereby affecting the hydrocarbon recovery from carbonate formations due to the effects on wettability. However, the concentrations of some ions affect the wettability while other do not. Adding certain anions, such as iodide, sulfate, and/or borate, into the brine solution can alter the brine/carbonate zeta-potential to become negative, thereby creating a repulsion between the brine/carbonate and brine/crude oil interfaces. This electrostatic repulsion alters the wettability towards more water-wet, and thereby leads to additional hydrocarbon recovery.

Provided in the present disclosure are compositions and methods for waterflooding in hydrocarbon recovery process from subterranean formations. The compositions contain dilute concentrations of sodium dihydrogen phosphate (NaH₂PO₄), such as 200-1000 ppm, in the injection water. Without wishing to be bound by any particular theory, it is believed that the dihydrogen phosphate ions (H₂PO₄⁻) interact with both calcite/brine and oil/brine interfaces to alter the surface charge to be negative or more negative and improve the wettability towards a water-wet state in carbonates, thereby increasing hydrocarbon production.

Furthermore, H₂PO₄⁻ ions can also reduce the pH of injection water towards a slightly acidic pH range, such as 5.0-5.5. Without wishing to be bound by any particular theory, it is believed that the slightly acidic pH can remove blockage of pore throats and cause mineral dissolution to increase permeability and improve the pore connectivity without causing corrosion of components of the hydrocarbon producing well.

The proposed water composition can thereby serve as an improved oil recovery (IOR) agent in water flooding applications to increase hydrocarbon recovery relative to other waterflooding methods. The methods include introducing 0.3 to 0.5 pore volumes of injection solution containing H₂PO₄⁻ ions as the main oil recovery slug followed by up to 1.0 pore volume of regular injection water as chase water. The main recovery slug can also be tapered by successively decreasing the dihydrogen phosphate ion concentrations. In some embodiments, the dihydrogen phosphate ion concentration is successively decreased from 1,000 ppm to 200 ppm using the concentration step size of 200 ppm.

### Definitions

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used in this disclosure, the term “subterranean formation” can refer to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region that is in fluid contact with the wellbore. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground that is in fluid contact with liquid or gaseous petroleum materials or water. In some embodiments, a subterranean formation is an oil well.

As used in this disclosure, the term “waterflooding” refers to a method of secondary recovery in which water is injected into the subterranean formation to displace residual hydrocarbons, such as oil, and increase the production of the hydrocarbon from the subterranean formation. The water from injection wells physically sweeps the displaced hydrocarbon, such as oil, to adjacent production wells.

Method for Enhancing Hydrocarbon Recovery from a Subterranean Formation

Provided in the present disclosure are methods for enhancing hydrocarbon recovery from a subterranean formation using waterflooding after primary production of the subterranean formation. The methods include waterflooding with injection solutions containing dihydrogen phosphate ions. In some embodiments, the subterranean formation is porous. In some embodiments, the subterranean formation includes carbonate formations, such as calcite.

Thus, provided in the present disclosure is a method of waterflooding, the method including introducing a first injection solution containing about 400 ppm to about 1000 ppm of dihydrogen phosphate ions into a subterranean formation and introducing a second injection solution containing dihydrogen phosphate ions into the subterranean formation, where the second injection solution has a concentration of dihydrogen phosphate ions of about 200 ppm to about 800 ppm, and a concentration of dihydrogen phosphate ions of at least about 200 ppm less than the first injection solution, and where at least one of the first injection solution and or the second injection solution displaces at least a portion of a hydrocarbon present in the subterranean formation.

### Injection Solutions for Waterflooding Containing Dihydrogen Phosphate Ions

In general, a first injection solution is introduced into a subterranean formation. In some embodiments, the concentration of dihydrogen phosphate ions in the first injection solution is about 200 ppm to about 1000 ppm, such as about 200 ppm to about 300 ppm, about 200 ppm to about 400 ppm, about 200 ppm to about 500 ppm, about 200 ppm to about 600 ppm, about 200 ppm to about 700 ppm, about 200 ppm to about 800 ppm, about 200 ppm to about 900 ppm, about 300 ppm to about 400 ppm, about 300 ppm to about 500 ppm, about 300 ppm to about 600 ppm, about 300 ppm to about 700 ppm, about 300 ppm to about 800 ppm, about 300 ppm to about 900 ppm, about 300 ppm to about 1000 ppm, about 400 ppm to about 500 ppm, about 400 ppm to about 600 ppm, about 400 ppm to about 700 ppm, about 400 ppm to about 800 ppm, about 400 ppm to about 900 ppm, about 400 ppm to about 1000 ppm, about 500 ppm to about 600 ppm, about 500 ppm to about 700 ppm, about 500 ppm to about 800 ppm, about 500 ppm to about 900 ppm, about 500 ppm to about 1000 ppm, about 600 ppm to about 700 ppm, about 600 ppm to about 800 ppm, about 600 ppm to about 900 ppm, about 600 ppm to about 1000 ppm, about 700 ppm to about 800 ppm, about 700 ppm to about 900 ppm, about 700 ppm to about 1000 ppm, about 800 ppm to about 900 ppm, about 800 ppm to about 1000 ppm, about 900 ppm to about 1000 ppm, about 200 ppm, about 300 ppm, about 400 ppm, about 500 ppm, about 600, ppm, about 700 ppm, about 800 ppm, about 900 ppm, or about 1000 ppm. In some embodiments, the concentration of dihydrogen phosphate ions in the first injection solution is about 1000 ppm. Without wishing to be bound by any particular theory, it is believed that a concentration of dihydrogen phosphate ions of more than about 1000 ppm can cause the injection solutions to be acidic and corrosive. It is also believed that a concentration of dihydrogen phosphate ions of more than about 1000 ppm can increase costs. On the other hand, it is believed concentrations of dihydrogen phosphate ions less than about 200 ppm may not impact the reservoir wettability.

In some embodiments, a second injection solution is introduced into the subterranean formation after introduction of the first injection solution. In some embodiments, the second injection solution has a concentration of dihydrogen phosphate ions of about 200 ppm to about 800 ppm, and a concentration of dihydrogen phosphate ions of at least about 200 ppm less than the first injection solution. In some embodiments, the concentration of dihydrogen phosphate ions in the second injection solution is about 200 ppm to about 800 ppm, such as about 200 ppm to about 300 ppm, about 200 ppm to about 400 ppm, about 200 ppm to about 500 ppm, about 200 ppm to about 600 ppm, about 200 ppm to about 700 ppm, about 300 ppm to about 400 ppm, about 300 ppm to about 500 ppm, about 300 ppm to about 600 ppm, about 300 ppm to about 700 ppm, about 300 ppm to about 800 ppm, about 400 ppm to about 500 ppm, about 400 ppm to about 600 ppm, about 400 ppm to about 700 ppm, about 400 ppm to about 800 ppm, about 500 ppm to about 600 ppm, about 500 ppm to about 700 ppm, about 500 ppm to about 800 ppm, about 600 ppm to about 700 ppm, about 600 ppm to about 800 ppm, about 700 ppm to about 800 ppm, about 200 ppm, about 300 ppm, about 400 ppm, about 500 ppm, about 600, ppm, about 700 ppm, or about 800 ppm. In some embodiments, the concentration of dihydrogen phosphate ions in the second injection solution is about 800 ppm. In some embodiments, the concentration of dihydrogen phosphate ions in the second injection solution is about 600 ppm. In some embodiments, the concentration of dihydrogen phosphate ions in the second injection solution is about 500 ppm. In some embodiments, the concentration of dihydrogen phosphate ions in the second injection solution is about 400 ppm. In some embodiments, the concentration of dihydrogen phosphate ions in the second injection solution is about 200 ppm.

In some embodiments, a first injection solution containing dihydrogen phosphate ions is introduced into the subterranean formation, and additional injection solutions are introduced such that the concentration of dihydrogen phosphate ions is successively tapered from about 1000 ppm to about 200 ppm, such as about 300 ppm to about 200 ppm, about 400 ppm to about 200 ppm, about 500 ppm to about 200 ppm, about 600 ppm to about 200 ppm, about 700 ppm to about 200 ppm, about 800 ppm to about 200 ppm, about 900 ppm to about 200 ppm, about 400 ppm to about 300 ppm, about 500 ppm to about 300 ppm, about 600 ppm to about 300 ppm, about 700 ppm to about 300 ppm, about 800 ppm to about 300 ppm, about 900 ppm to about 300 ppm, about 1000 ppm to about 300 ppm, about 500 ppm to about 400 ppm, about 600 ppm to about 400 ppm, about 700 ppm to about 400 ppm, about 800 ppm to about 400 ppm, about 900 ppm to about 400 ppm, about 1000 ppm to about 400 ppm, about 600 ppm to about 500 ppm, about 700 ppm to about 500 ppm, about 800 ppm to about 500 ppm, about 900 ppm to about 500 ppm, about 1000 ppm to about 500 ppm, about 700 ppm to about 600 ppm, about 800 ppm to about 600 ppm, about 900 ppm to about 600 ppm, about 1000 ppm to about 600 ppm, about 800 ppm to about 700 ppm, about 900 ppm to about 700 ppm, about 1000 ppm to about 700 ppm, about 900 ppm to about 800 ppm, about 1000 ppm to about 800 ppm, or about 1000 ppm to about 900 ppm. In some embodiments, a first injection solution containing dihydrogen phosphate ions is introduced into the subterranean formation, and additional injection solutions are introduced such that the concentration of dihydrogen phosphate ions is successively tapered from about 1000 ppm to about 200 ppm.

In some embodiments, the dihydrogen phosphate ion concentration step size between successive injection solutions is reduced by about 100 ppm, about 200 ppm, about 300 ppm, about 400 ppm, about 500 ppm, about 600 ppm, about 700 ppm, or about 800 ppm. In some embodiments, the dihydrogen phosphate ion concentration step size between successive injection solutions is reduced by about 200 ppm. Without wishing to be bound by any particular theory, it is believed that tapering the concentration by successively decreasing the dihydrogen phosphate ions at step size of about 200 ppm can maximize the wettability alteration process and do so without excess costs. Using a smaller step-size, such as about 100 ppm, would increase operational costs without any significant benefits relative to a step size of about 200 ppm. Using a larger step size, such as about 500 ppm, may result in reduced hydrocarbon recovery relative to a step size of about 200 ppm.

In some embodiments, two, three, four, or five injection solutions containing dihydrogen phosphate ions are successively introduced into the subterranean formation, where each successive injection solution is less concentrated than the previous injection solution.

In some embodiments, a first injection solution containing about 1000 ppm of dihydrogen phosphate ions, a second injection solution containing about 800 ppm of dihydrogen phosphate ions, a third injection solution containing about 600 ppm of dihydrogen phosphate ions, a fourth injection solution containing about 400 ppm of dihydrogen phosphate ions, and a fifth injection solution containing about 200 ppm of dihydrogen phosphate ions are successively introduced into the subterranean formation.

Examples of the water sources for the injection solution, such as the first, second, third, fourth, and fifth injection solution, include aquifer water, surface water and seawater. In some embodiments, the water source for the injection solution is seawater. In some embodiments, a salt containing dihydrogen phosphate ions, such as sodium dihydrogen phosphate (NaH₂PO₄), and/or potassium dihydrogen phosphate (KH₂PO₄), is added to the water source to obtain the injection solution. In some embodiments, a salt containing dihydrogen phosphate ions is added to an existing water injection pipeline, such as, a seawater injection pipeline, prior to a wellhead of an injection well.

In some embodiments, the amount of the injection solution, such as the first, second, third, fourth and fifth injection solution, is about 0.3 to about 0.5 pore volumes, such as about 0.3 to about 0.4 pore volumes, about 0.4 to 0.5 pore volumes, about 0.3 pore volumes, about 0.4 pore volumes, about 0.5 pore volumes. In some embodiments, the amount the injection solution is about 0.3 to about 0.5 pore volumes

In some embodiments, the pH of the injection solution, such as the first, second, third, fourth and fifth injection solution, is about 5.0 to about 5.5, such as about 5.0 to about 5.1, about 5.0 to about 5.2, about 5.0 to about 5.3, about 5.0 to about 5.4, about 5.1 to about 5.2, about 5.1 to about 5.3, about 5.1 to about 5.4, about 5.1 to about 5.5, about 5.2 to about 5.3, about 5.2 to about 5.4, about 5.2 to about 5.5, about 5.3 to about 5.4, about 5.3 to about 5.5, about 5.4 to about 5.5, about 5.0, about 5.1, about 5.2, about 5.3, about 5.4, or about 5.5. In some embodiments, the pH of the injection solution is about 5.0 to about 5.5. Without wishing to be bound by theory, it is believed that the slightly acidic pH of the injection solution can remove blockage of pore throats and cause some mineral dissolution resulting in an increase in permeability and improved pore connectivity, without causing corrosion of components of the hydrocarbon producing well.

### Surface Charge and Wettability

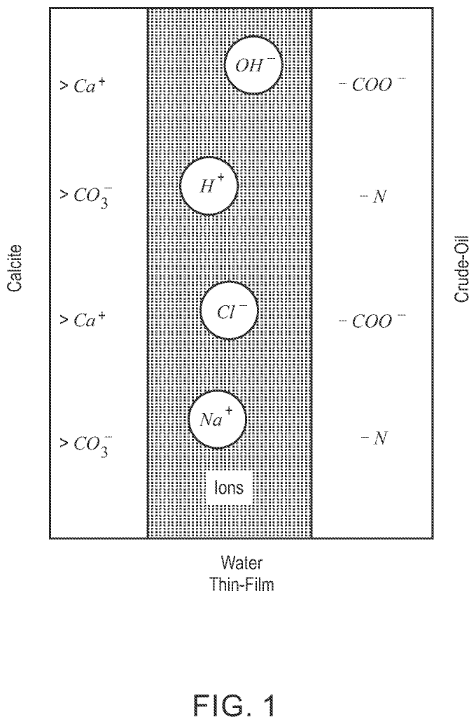

FIG. 1 depicts different ions in a water thin-film between calcite and crude oil surfaces from a brine. Without wishing to be bound by any particular theory, it is believed that dissolved ions can be adsorbed on the crude oil, calcite and brine surfaces, thereby creating an overall surface charge on each interface. The surface charge has a corresponding zeta-potential electrokinetic parameter that can be experimentally measured.

Without wishing to be bound by any particular theory, it is believed that seawater includes high concentration of divalent cations, such as Mg′ and Ca′, resulting in a positive surface charge for calcite surfaces. Adding dihydrogen phosphate ions to the seawater can create surface complexes adsorbed on the calcite that alter the surface charge to a negative surface charge from a positive surface charge. Altering the brine/carbonate zeta-potential to become more negative can create a repulsion between the brine/carbonate and brine/crude-oil interfaces, altering the wettability towards more water-wet, thereby increasing hydrocarbon recovery. The surface charges in crude oil are mainly negative due to carboxylate groups in the crude oil composition. Thus, brines containing dihydrogen phosphate ions may be expected to have a larger impact on the surface charge, as measured by zeta-potentials, of calcite/brine interfaces relative to crude oil/brine interfaces. An injection solution containing about 1000 ppm of dihydrogen phosphate ions in seawater can cause a change in the zeta-potential from positive to negative for brine/carbonate interfaces while being safe to employ in field operations and cost-effective.

Changes in the wettability, such as due to changes in the surface charge, can be observed through contact angle measurements. A decrease in the contact angle would indicate that the system is shifted to a more water-wet state, thereby leading to increased hydrocarbon production. Chase Water

In some embodiments, a chase water is introduced to the subterranean formation after introduction of all of the injection solutions employed. In some embodiments, the amount of chase water introduced is about 0.5 to about 1.0 pore volumes, such as about 0.5 to about 0.6 pore volumes, about 0.5 to about 0.7 pore volumes, about 0.5 to about 0.8 pore volumes about 0.5 to about 0.9 pore volumes, about 0.6 to about 0.7 pore volumes, about 0.7 to about 0.8 pore volumes, about 0.7 to about 0.9 pore volumes, about 0.7 to about 1.0 pore volumes, about 0.8 to about 0.9 pore volumes, about 0.8 to about 1.0 pore volumes, about 0.9 to about 1.0 pore volumes, about 0.5 pore volumes, about 0.6 pore volumes, about 0.7 pore volumes, about 0.8 pore volumes, about pore volumes, or about 1.0 pore volumes. In some embodiments, the amount of chase water introduced is about 1.0 pore volumes. In some embodiments, the chase water contains aquifer water, surface water and/or seawater.

Methods of Using the Injection Solutions Containing Dihydrogen Phosphate Ions for WaterFlooding

Thus, provided in the disclosure are methods of using the injection solutions described herein for waterflooding. In some embodiments, the methods of the present disclosure result in increased oil recovery, such as from a carbonate formation.

Provided in the present disclosure is a method of waterflooding, where the method involves introducing a first injection solution including about 400 ppm to about 1000 ppm of dihydrogen phosphate ions into a subterranean formation, followed by introduction of a second injection solution including dihydrogen phosphate ions with a concentration of dihydrogen phosphate ions of about 200 ppm to about 800 ppm, and a concentration of dihydrogen phosphate ions of at least about 200 ppm less than the first injection solution into a subterranean formation, thereby displacing at least a portion of a hydrocarbon present in the subterranean formation. In some embodiments, the first solution and/or the second solution has a pH of about 5.0 to 5.5. In some embodiments, the first solution and/or the second solution includes seawater. In some embodiments, an amount of the first solution and/or the second solution introduced into the subterranean formation is about 0.3 to 0.5 pore volumes. In some embodiments, the first injection solution includes 1000 ppm of dihydrogen phosphate ions. In some embodiments, a chase solution, including aquifer water, surface water, seawater, or combinations thereof, is introduced into the subterranean formation after the first and second injection solutions. In some embodiments, an amount of the chase solution introduced into the subterranean formation is about 0.5 to about 1.0 pore volumes. In some embodiments, the subterranean formation includes a carbonate formation. In some embodiments, the first injection solution is introduced after primary production of a hydrocarbon from the subterranean formation. In some embodiments, the method of waterflooding further includes producing the hydrocarbon from the subterranean formation.

Also provided in the present disclosure is a method of waterflooding, where the method involves introducing a first injection solution including about 1000 ppm of dihydrogen phosphate ions into a subterranean formation; introducing a second injection solution including about 800 ppm of dihydrogen phosphate ions into the subterranean formation; introducing a third injection solution including about 600 ppm of dihydrogen phosphate ions into the subterranean formation; introducing a fourth injection solution including about 400 ppm of dihydrogen phosphate ions into the subterranean formation; and introducing a fifth injection solution including about 200 ppm of dihydrogen phosphate ions into the subterranean formation, wherein at least one of the first injection solution, the second injection solution, the third injection solution, the fourth injection solution, and the fifth injection solution displaces at least a portion of a hydrocarbon present in the subterranean formation. In some embodiments, the first injection solution, the second injection solution, the third injection solution, the fourth injection solution, and/or the fifth injection solution has a pH of about 5.0 to about 5.5. In some embodiments, the first injection solution, the second injection solution, the third injection solution, the fourth injection solution, and/or the fifth injection solution includes seawater. In some embodiments, an amount of the first injection solution, the second injection solution, the third injection solution, the fourth injection solution, and/or the fifth injection solution introduced into the subterranean formation is about 0.3 to about 0.5 pore volumes. In some embodiments, a chase solution, including aquifer water, surface water, seawater, or combinations thereof, is introduced into the subterranean formation after the first, second, third, fourth and fifth injection solutions. In some embodiments, an amount of the chase solution introduced into the subterranean formation is about 0.5 to about 1.0 pore volumes. In some embodiments, the subterranean formation includes a carbonate formation. In some embodiments, the first injection solution is introduced after primary production of a hydrocarbon from the subterranean formation. In some embodiments, the method of waterflooding further includes producing the hydrocarbon from the subterranean formation.

### EXAMPLES

### Example 1—Zeta-Potential Measurements

Brine samples were prepared by adding 0 ppm, 500 ppm or 1000 ppm of sodium dihydrogen phosphate to each of the water sources in Table 1.

TABLE 1
The composition of different brines
Brine samples (concentration (mg/L))

| | Seawater | SmartWater | Na₂SO₄ |
|---|---|---|---|
| Na⁺ | 18,300 | 1824 | 1865 |
| Cl⁻ | 32,200 | 3220 | — |
| Ca²⁺ | 650 | 65 | — |
| Mg²⁺ | 2,110 | 211 | — |
| SO₄⁻² | 4,290 | 429 | 3896 |
| HCO3− | 120 | — | — |
| Total | 57,670 | 5,761 | 5,761 |
| dissolved | | | |
| Solids, | | | |
| ppm | | | |
| Initial | 7.66 | 7.29 | 6.58 |
| pH | | | |

Contaminants were removed from the crude oil sample by filtration and centrifugation. Oil/brine emulsions were prepared by adding an oil drop to 5 mL of each brine. A pure calcium carbonate disk that was 99 wt. % CaCO₃ was used for the calcine/brine suspensions. X-ray diffraction (XRD) was used to confirm the calcite purity. A granite mill was used to grind the calcite disk at ambient conditions without introducing contaminants. For the calcite/brine suspension, 20 mL of each brine was mixed with 0.1 g of fine powder of ground calcite, then 5 mL of the brine with ground calcite was transferred to a new vial with 15 mL of calcite free brine. The samples were sonicated after each step involving a suspension to prevent the agglomeration of particles. In order to maintain consistent experimental conditions, solid/liquid and liquid/liquid proportions were kept fixed.

Zeta-potential measurements were conducted via phase analysis light scattering using ZetaPALS instrument. Measurements were performed at least twice until consistent results were obtained. Two cells were used, one for calcite/brine suspensions and the other for oil/brine emulsions.

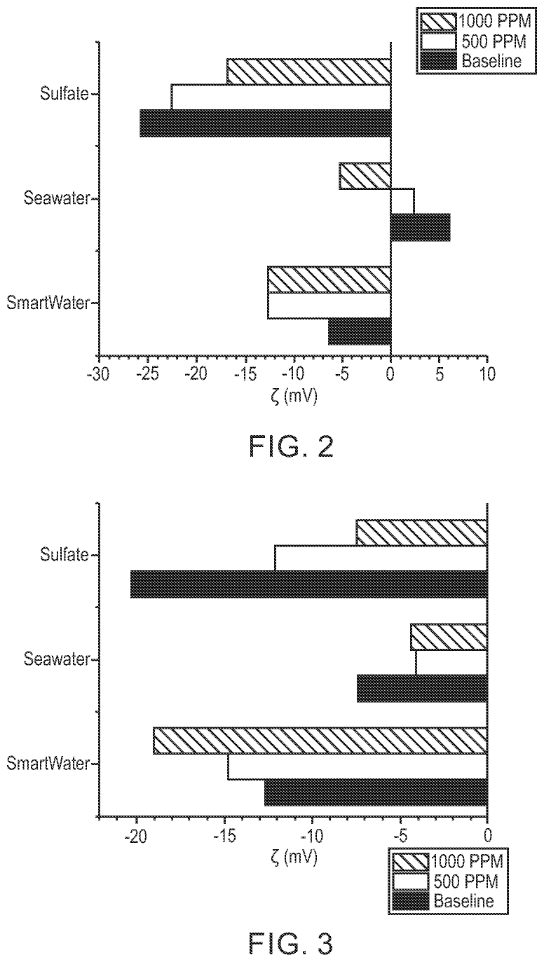

FIGS. 2 and 3 show the zeta-potential measurements for both brine/calcite and crude oil/brine interfaces, respectively, at atmospheric conditions for each of the brine samples prepared. FIG. 2 demonstrates that the sodium dihydrogen phosphate at a concentration of 1000 ppm caused the zeta-potential value to significantly decrease and shift from a positive value of 7 mV for seawater without added NaH₂PO₄ to a negative value of −6 mV for seawater with 1000 ppm NaH₂PO₄. The pH of this brine decreased from about 7.5 for seawater without added NaH₂PO₄ to about 5.5 for seawater with 1000 ppm of NaH₂PO₄.

All measured zeta-potentials for the oil/brine interface were negative, as shown in FIG. 3. Adding sodium dihydrogen phosphate altered the magnitude of the zeta-potentials.

The results demonstrate that sodium dihydrogen phosphate has a greater impact on the zeta-potentials of calcite/brine interfaces relative to crude oil/brine interfaces which did not have an appreciable trend.

### Example 2—Contact Angle Measurements

Contact angle measurements were performed on seawater samples without and with 1000 ppm of sodium dihydrogen phosphate on a flat carbonate chip. The carbonate chip was saturated with brine, centrifuged, and aged in dead oil for four days. Next, the sample was mounted inside the chamber, and the baseline brine was injected. Once the chamber was filled and no leakage was observed, an oil needle was used to place a droplet at the surface of the chip. Pressure and temperature were maintained at 1000 psig and 70° C., respectively, when the tests were conducted. A video camera filmed the surface with the drop, and computer software was used to calculate the contact angle from the image.

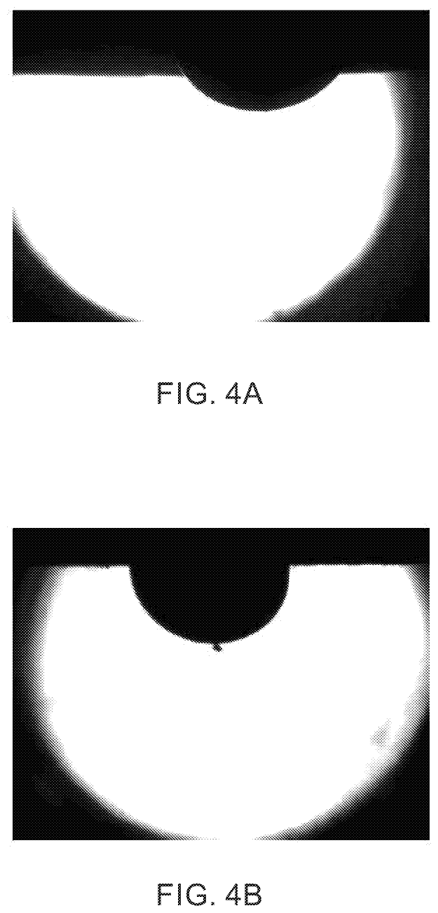

The seawater had a contact angle of 135 degrees and the seawater with 1000 ppm of NaH₂PO₄ had a water contact angle of 90 degrees, as shown in FIGS. 4A and 4B, respectively. Adding sodium dihydrogen phosphate altered the seawater/carbonate zeta-potential to become negative (due to adsorption of dihydrogen phosphate and hydrogen phosphate negative ions), thereby creating a repulsion between the brine/carbonate and brine/crude-oil interfaces. This electrostatic repulsion stabilized the water film sandwiched between the oil drop and calcite surface and altered the wettability towards more water-wet, thereby leading to additional oil recovery. The addition of NaH₂PO₄ decreased the contact angle by 45 degrees, altering the system to more water-wet conditions. Thus, seawater with 1000 ppm of NaH₂PO₄ is the most promising brine recipe for waterflooding as the zeta-potential changed from positive to negative for seawater/calcite. 1000 ppm showed a strong effect on zeta-potential while being safe to employ in field operations and cost-effective.

### Example 3—Surface Modeling

A surface complexation model was used to describe the equilibrium state of ion adsorption based on specified surface reactions and rationalize the observed behavior. To validate the model, the experimental zeta-potential values were history-matched with predicted model values by manipulating the surface-reaction equilibrium constants.

In the surface complexation model, the concentration of adsorbed surfaces complexes (adsorbed ions) determined the total surface charge as:

$$σ = \frac{F}{S A} Σ {z}_{i} {c}_{i} , \qquad ( 1 )$$

where σ is the surface charge density (C/m²), F is the Faraday constant (96493.5 C/mol), S is the surface material mass (g), A is the specific surface area (m²/g), zⱼ is the ionic electric charge, and cᵢ is the adsorbed ion concentration (mol). The surface charge and surface-potential are related through the Gouy-Chapman model:

$$σ = {( 8000 {∈}_{o} {∈}_{w} RT 1 )}^{1 / 2} sinh ( \frac{v F Ψ}{2 RT} ) , \qquad ( 2 )$$

where εₒ is the vacuum permittivity

$$( \frac{{c}^{2}}{mJ} ) ,$$

εₒ is the water relative permittivity, W is the surface-potential (V), R is the gas constant

$$( \frac{J}{mol K} ) ,$$

T is the temperature (K), I is the brine ionic strength (mol/l), and v is the electrolyte ionic charge which was assumed to be unity.

The site density for calcite surface was 4.95 sites/nm², while the crude oil surface had a site density of 0.47 sites/nm². The calcite specific surface area was 1 m²/g, while the crude oil specific area was 0.5 m²/g.

The intrinsic equilibrium constants (shown in table 2) were considered as fitting parameters and varied in the SCM to match the measured zeta-potentials. The site density and specific surface area of the considered surfaces were fixed.

The history-matching included surface reactions that capture the formation of dihydrogen phosphate ions on top of divalent cations as shown in Table 2.

TABLE 2
Calcite surface complexation reactions involving
divalent cations and dihydrogen phosphate

| | Equilibrium |
|---|---|
| Calcite Surface Reaction | Constant (log₁₀ Kᵢₙₜ) |
| >CaOH + Mg²⁺ + H₂PO₄⁻ ↔ >CaOMgHPO₄⁻ + 2H⁺ | −7.35 |
| >CaOH + Ca²⁺ + H₂PO₄⁻ ↔ >CaOCaHPO₄⁻ + 2H⁺ | −6.65 |
| >CaOH + Mg²⁺ + H₂PO₄⁻ ↔ >CaOMgH₂PO₄ + H⁺ | −2.65 |
| >CaOH + Ca²⁺ + H₂PO₄⁻ ↔ >CaOCaH₂PO₄ + H⁺ | −4.35 |

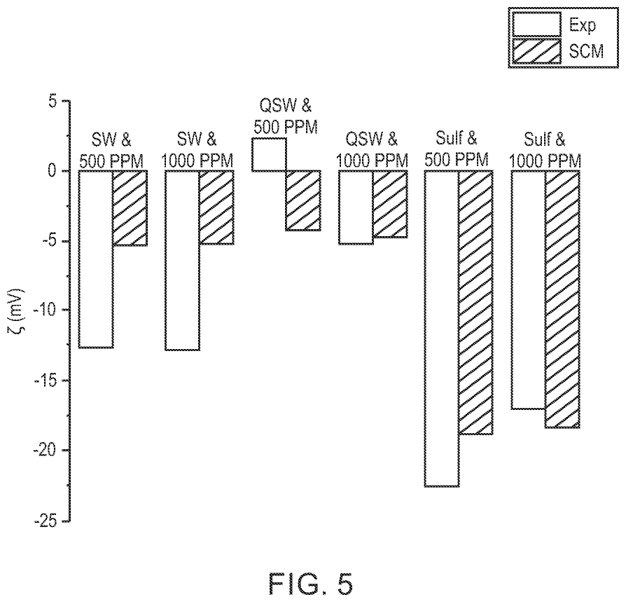

FIG. 5 shows the comparison between the experimental and modeling results. The trend was qualitatively captured by the model.

The dihydrogen phosphate ions bind as a ternary component that mitigate the effect of positive divalent cations (magnesium and calcium), resulting in an overall negative surface-charge with a corresponding negative zeta-potential.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. For example, in some embodiments, in addition to, or instead of a salt of dihydrogen phosphate ions, such as sodium dihydrogen phosphate and/or potassium dihydrogen phosphate, sodium chloride (NaCl) and/or sodium sulfate (Na₂SO₄) can be used in the injection solution for waterflooding.

What is claimed is:

1. A method of waterflooding, comprising:
introducing a first injection solution comprising about 400 ppm to about 1000 ppm of dihydrogen phosphate ions into a subterranean formation; and
introducing a second injection solution comprising dihydrogen phosphate ions into the subterranean formation;
wherein the second injection solution has a concentration of dihydrogen phosphate ions of about 200 ppm to about 800 ppm, and a concentration of dihydrogen phosphate ions of at least about 200 ppm less than the first injection solution; and
wherein at least a portion of a hydrocarbon present in the subterranean formation is displaced.

2. The method of claim 1, wherein at least one of the following holds:
the first injection solution has a pH of about 5.0 to about 5.5; or
the second injection solution has a pH of about 5.0 to about 5.5.

3. The method of claim 1, wherein at least one of the following holds:
the first injection solution comprises seawater; or
the second injection solution comprises seawater.

4. The method of claim 1, wherein at least one of the following holds:
an amount of the first injection solution introduced into the subterranean formation is about 0.3 to about 0.5 pore volumes; or
an amount of the second injection solution introduced into the subterranean formation is about 0.3 to about 0.5 pore volumes.

5. The method of claim 1, wherein the first injection solution comprises about 1000 ppm of dihydrogen phosphate ions.

6. The method of claim 5, wherein at least one of the following holds:
the first injection solution comprises seawater; or
the second injection solution comprises seawater.

7. The method of claim 1, further comprising introducing a chase solution, comprising aquifer water, surface water, seawater, or combinations thereof, into the subterranean formation.

8. The method of claim 7, wherein an amount of the chase solution introduced into the subterranean formation is about 0.5 to about 1.0 pore volumes.

9. The method of claim 1, wherein the subterranean formation comprises a carbonate formation.

10. The method of claim 1, wherein the first injection solution is introduced after primary production of a hydrocarbon from the subterranean formation.

11. The method of claim 1, further comprising producing the hydrocarbon from the subterranean formation.

12. A method of waterflooding, comprising:
introducing a first injection solution comprising about 1000 ppm of dihydrogen phosphate ions into a subterranean formation;
introducing a second injection solution comprising about 800 ppm of dihydrogen phosphate ions into the subterranean formation;
introducing a third injection solution comprising about 600 ppm of dihydrogen phosphate ions into the subterranean formation;
introducing a fourth injection solution comprising about 400 ppm of dihydrogen phosphate ions into the subterranean formation; and
introducing a fifth injection solution comprising about 200 ppm of dihydrogen phosphate ions into the subterranean formation,
wherein at least one of the first injection solution, the second injection solution, the third injection solution, the fourth injection solution, and the fifth injection solution displaces at least a portion of a hydrocarbon present in the subterranean formation.

13. The method of claim 12, wherein at least one of the first injection solution, the second injection solution, the third injection solution, the fourth injection solution, and the fifth injection solution has a pH of about 5.0 to about 5.5.

14. The method of claim 12, wherein at least one of the first injection solution, the second injection solution, the third injection solution, the fourth injection solution, and the fifth injection solution comprises seawater.

15. The method of claim 12, wherein an amount of at least one of the first injection solution, the second injection solution, the third injection solution, the fourth injection solution, and the fifth injection solution introduced into the subterranean formation is about 0.3 to about 0.5 pore volumes.

16. The method of claim 12, further comprising injecting a chase solution, comprising aquifer water, surface water, seawater, or combinations thereof, into the subterranean formation.

17. The method of claim 16, wherein an amount of the chase solution introduced into the subterranean formation is about 0.5 to about 1.0 pore volumes.

18. The method of claim 12, wherein the subterranean formation comprises a carbonate formation.

19. The method of claim 12, wherein the first injection solution is introduced after primary production of a hydrocarbon from the subterranean formation.

20. The method of claim 12, further comprising producing the hydrocarbon from the subterranean formation.
